(19) United States
(12) Patent Application Publication
(10) Pub. No.: US 2024/0261610 A1
(43) Pub. Date: Aug. 8, 2024

(54) AUTOMATIC COMMUNICATION SYSTEM FOR LOCAL SUPPRESSION OF RISING TEMPERATURE OR FIRE EXTINGUISHING IN ELECTRICAL EQUIPMENT CONNECTED TO A POWER SUPPLY

(71) Applicant: MEGELLAN, SE, Prague 3, Zizkov (CZ)

(72) Inventors: Marek Duda, Bohumín, Nový Bohumín (CZ); Peter Roncak

(73) Assignee: MEGELLAN, SE, Prague 3, Zizkov (CZ)

(21) Appl. No.: 18/567,283

(22) PCT Filed: Jun. 17, 2022
(86) PCT No.: PCT/CZ2022/000027

§ 371 Date: Dec. 5, 2023

(30) Foreign Application Priority Data
Jun. 19, 2021 (CZ) PV 2021-309

(51) Int. Cl. A62C 3/16; A62C 35/02; A62C 37/11; G08B 17/06; H04W 4/38

(52) U.S. Cl. CPC A62C 3/16; A62C 35/023; A62C 37/11; G08B 17/06; H04W 4/38

(57) ABSTRACT

A transmitter (“T”) in a protected area connected to an electrical circuit of an electrical distribution box in which is a receiver (“R”).

The T includes a cooling medium carrier (“CMC”) with a fire extinguishing effect A communication control unit The CCU includes a temperature or smoke or a light spectrum sensor, an RF transmitter for wireless communication between the T and the R, a control LED for setting and pairing with the R. The R includes a power supply, at least one LED for setting the pairing with the T, at least one LED for monitoring an error of the T arranged in the protected area, and RF receiving components for wireless communication. A disconnector disconnects the protective area as a rising temperature is detected from the power source. The system identifies a containment compartment with the CMC that is damaged.

### FIELD OF THE INVENTION

The invention relates to the protection of electrical equipment such as sockets, switches, electrical appliances, extension cables, connectors, and other electrical equipment which are coupled to equipment connected to an electrical power source, for example electrical distribution box, where temperature can rise or fire can occur.

### BACKGROUND OF THE INVENTION

In lighting circuits, socket circuits or circuits with connected appliances such as electric ovens or hotplates, undesirable thermal phenomena can occur, the negative effects of which can lead to a gradual loss of functionality or destruction of these devices and in extreme cases can even lead to fire. This can be caused by various processes such as undesirable chemical reactions, electrical short circuits, overheating of the system, formation of the electric arcing, burning of operating fluids, etc.

The known protections for socket or light circuits of electrical distribution boxes from state of art are so-called arc protectors, which have the ability to mitigate the effect of a fault arc by disconnecting from the electrical source. However, arc protectors do not have the extinguishing capability or the ability to prevent rising temperatures in switchboards and their lighting, socket and other circuits.

### SUMMARY OF THE INVENTION

The above deficiencies are eliminated by an automatic communication system for local suppression of rising temperature or fire suppression in electrical equipment connected to an electrical power source, the essence of which is that it consists of a transmitter arranged in at least one protected electrical device, such as electrical sockets, switches, electrical appliances, extension cords, connectors, connected to electrical circuits, and a receiver arranged at the location of the electrical power source, for example in an electrical distribution box.

Wherein the transmitter includes a cooling medium carrier with a fire extinguishing effect, which is closed by a first terminal on one side, under which a communication control unit with a battery is arranged, and on the other side the cooling medium carrier with a fire extinguishing effect is closed by a second terminal.

The transmitter is also powered externally. The cooling medium carrier with extinguishing effect is made of polymer materials, it is a low pressure device up to 1 MPa. The transmitter's communication control unit contains a temperature or smoke sensor or a light spectrum sensor, an RF transmitter for communication e.g. WIFI, Bluetooth, LAN and others, a pairing button for connecting the transmitter's wireless communication with the receiver, arranged in an electrical distribution box in which a protected area, e.g. a socket, is connected in the electrical circuit, and the communication control unit contains a control LED for setting the pairing of the transmitter with the receiver.

Wherein the receiver that is arranged in a device with a power supply, such as a electrical distribution box, is compatible with the DIN rail. The receiver enables pairing wireless communication with the transmitter using the pairing button, receiving RF for communication via WIFI, Bluetooth, LAN, etc., receiving a signal about the rising temperature in the protected area, disconnecting individual electrical circuits with rising temperature in the protected area from the electric current and transmitting such a signal to the signaling device.

The receiver includes an internal or external power supply, at least one monitoring LED for setting the pairing with the transmitter, and at least one LED for monitoring the transmitter arranged in the protected area to detect its error.

The transmitter and receiver of the system communicate wirelessly after pairing with each other. Activation of the system is triggered by increasing heat.

When the temperature rises in a protected area, such as an electrical outlet, a transmitter located in the protected area sends a signal to a receiver located at the location of the power source, such as an electrical distribution box, where a disconnector disconnects the electrical circuit where the transmitter is located. The said transmitter, comprising a carrier of a cooling medium with extinguishing effects, in which an opening/nozzle is formed due to the rising temperature, through which the cooling medium with extinguishing effects escapes into the space of the protected device, where it cools the rising temperature or extinguishes the resulting fire. System activation from 30° C. in a protected area.

Disconnecting the protected area from the power source prevents a electrical short circuit from occurring again.

The receiver shows digital or analogue signaling/initiation indication, i.e. the cooling medium with extinguishing effects is discharged from the cooling medium carrier with extinguishing effects, which is arranged in the transmitter, and due to the rising temperature this carrier breaks down, the cooling medium with extinguishing effects is discharged into a protected area, e.g. a socket, the transmitter sends a signal to the receiver, whereby the protected area, such as a socket or other electrical device, in which the damaged cooling medium carrier is located is accurately identified and easy replacement of the transmitter with the cooling medium carrier occurs.

The installation of an automatic communication system for local suppression of rising temperatures or extinguishing in electrical equipment connected to a power source is very simple.

The dimensions of the transmitter system are adapted to the size of the protected areas, which are for example sockets, switches, electrical appliances, extension cables, connectors, and other electrical equipment.

The automatic communication system for local suppression of rising temperature or fire extinguishing in electrical equipment connected to the power source is an active system.

The transmitter of the system also works passively—on its own, without a battery or external power supply, when the temperature in the protected device rises, the carrier of the cooling medium with extinguishing effects automatically breaks down and the medium enters the protected space in which the transmitter is arranged through the opening.

Automatic system communication for local suppression of rising temperature or extinguishing in electrical equipment connected to a power source is a safe product, does not endanger human health in terms of electrical energy or cooling medium with extinguishing effects. And the protected equipment is not damaged either.

### BRIEF DESCRIPTION OF THE DRAWINGS

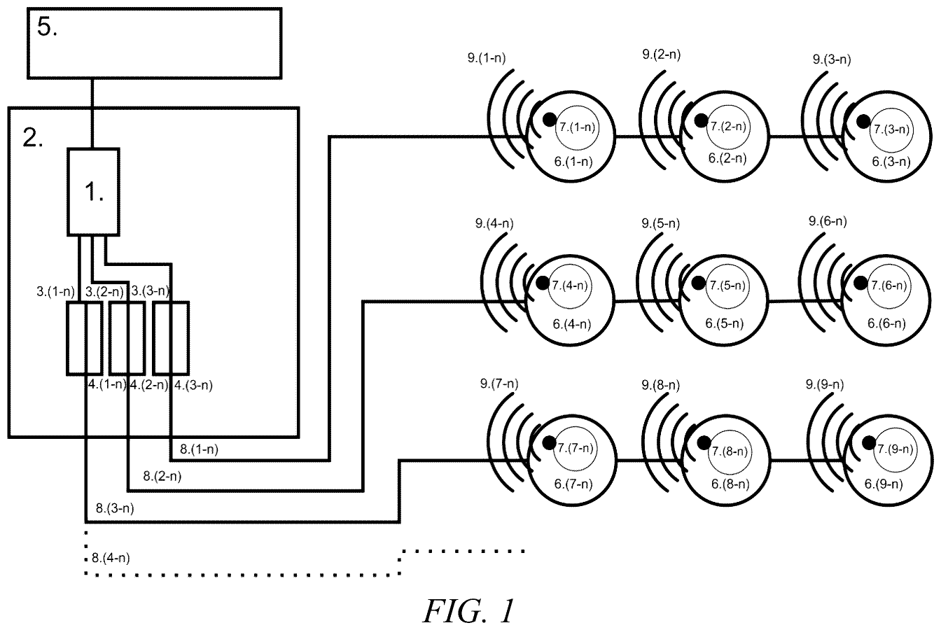

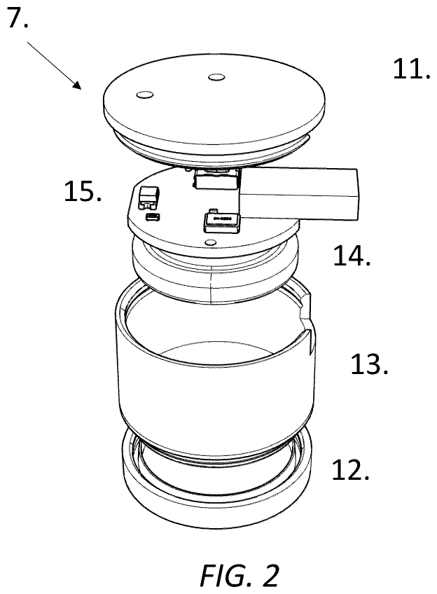

The automatic communication system for local suppression of rising temperature or fire extinguishing in electrical equipment connected to a power source is further explained in the attached drawings, where FIG. 1 shows the block diagram of the system and FIG. 2 shows the transmitter of the system in a spatial representation.

### EXAMPLES OF INVENTION EMBODIMENT

The automatic communication system for local suppression of rising temperature or fire extinguishing in electrical equipment connected to a power source, shown in the accompanying drawings, represents the protection of electrical sockets, switches, connectors and the like, generally protected spaces 6, which are connected in the electrical circuits 8 of the electrical distribution box 2. The system comprises a transmitter 7 arranged in each protected area 6 connected in at least one electrical circuit 8 of the electrical distribution box 2, and a receiver 1 arranged at the location of the power source—in the electrical distribution box 2.

Wherein the transmitter 1 comprises a cooling medium carrier 13 having an extinguishing effect, the cooling medium carrier 13 being closed on one side by a first terminal 11 under which a communication control unit 15 with a battery 14 is arranged, and on the other side the cooling medium carrier 13 having an extinguishing effect is closed by a second terminal 12. The cooling medium carrier 13 with extinguishing effect is made of polymer materials, it is a low pressure device up to 1 MPa.

The communication control unit 15 includes a temperature sensor, an RF transmitter for wireless communication 9, a pairing button for pairing the wireless communication 2 with the receiver 1 arranged in the electrical distribution box 2, and further, the communication control unit 15 includes a control LED for setting the pairing with the receiver 1 arranged in the electrical distribution box 2. Transmitter 7 components—sensor, RF transmitter, pairing button, and control LED are not plotted.

The receiver 1 of the system is arranged in the electrical distribution box 2 and is DIN rail compatible.

By means of the pairing button, the receiver 1 enables pairing of communication with the transmitter 7, receiving RF, WIFI, Bluetooth, LAN, disconnection of individual electrical circuits 8 of the electrical distribution box 2 from the electric current by means of the disconnector 3 on the basis of the signal from the transmitter 7 about the rising temperature in the protected area 6, sending the signal about the rising temperature in the protected area 6 to the signaling device 5.

Wherein the receiver 1 comprises a power supply internal or external, at least one monitoring LED for setting the pairing with the transmitter 7, and an LED for monitoring the transmitter 7 arranged in the protected space 6 for detecting an error thereof.

Components of receiver 1—pairing button, power supply, control LED, WIFI receiver, Bluetooth, LAN are not plotted.

The transmitter 7 and receiver L of the system communicate wirelessly after pairing 9. Activation of the system is triggered by a temperature sensor.

When the temperature rises in one of the protected areas 6, the transmitter 7, located in this protected area 6, sends a signal to the receiver 1, which is located at the location of the power source, in the electrical distribution box 2, whereupon the electrical circuit 8, where this transmitter 1 is located, is disconnected by the disconnector 3. The said transmitter 7, comprising a carrier 13 of a cooling medium with extinguishing effects, in which an opening/nozzle is formed due to the rising temperature, through which the cooling medium with extinguishing effects escapes into the space of the protected device 6, where it cools the rising temperature or extinguishes the resulting fire.

The nozzle in the cooling medium carrier 13 with extinguishing effects in the transmitter 7 is not drawn.

System activation from 30° ° C. in a protected area.

Disconnecting the protected area from the power source prevents a electrical short circuit from occurring again.

The receiver 1 shows digital or analogue signaling/initiation indication, i.e. the cooling medium with extinguishing effects is discharged from the cooling medium carrier 13 with extinguishing effects, which is arranged in the transmitter 1, and due to the rising temperature this carrier 13 breaks down, the cooling medium with extinguishing effects is discharged into a protected area 6, e.g. a socket, the transmitter 7 sends a signal to the receiver 1, whereby the protected area 6, such as a socket or other electrical device, in which the damaged cooling medium carrier 13 is located is accurately identified and easy replacement of the transmitter 7 with the cooling medium carrier 13 occurs.

The installation of an automatic system for local suppression of rising temperatures or extinguishing in electrical equipment connected to a power source is very simple.

The dimensions of the transmitter 13 of the system are adapted to the size of the protected areas 6 in which they are arranged.

The automatic communication system for local suppression of rising temperature or fire extinguishing in electrical equipment connected to the power source is an active system.

The transmitter 7 of the system also operates passively—by itself, without the battery 14 and without external power supply, the increased temperature in the protected device 6 automatically breaks the carrier 13 of the cooling medium with extinguishing effects, and this medium enters the protected space 6 in which the transmitter 7 is arranged through the opening in the carrier 13.

### INDUSTRIAL/TECHNICAL APPLICABILITY

The automatic communication system for local suppression of rising temperature or fire extinguishing in electrical equipment connected to the power source is used in all possible electrical equipment such as sockets, switches, electrical appliances, extension cables, connectors, and other electrical equipment that are connected to the equipment connected to the power source, such as electrical distribution boxes, IT cabinets, etc., where the temperature may rise or a fire may occur.

Automatic system for local suppression of rising temperature or extinguishing in electrical equipment connected to a power source is a safe product, does not endanger human health in terms of electrical energy or cooling medium with extinguishing effects. And the protected equipment is not damaged either.

1. An automatic communication system for local suppression of rising temperature or fire extinguishing in electrical equipment connected to a power source, comprising:
a transmitter (7) arranged in at least one protected area, connected in at least one electrical circuit (8) of an electrical distribution box (2), wherein the system further comprises
a receiver (1) arranged in the electrical distribution box (2),
wherein the transmitter (7) comprises a carrier (13) of the extinguishing cooling medium, which is closed by a first terminal (11) on one side, under which a communication control unit (15) with a battery (14) is arranged, and further the communication control unit (15) comprises a control light emitting diode (LED) for setting the pairing with the receiver (1), and on the other side a carrier (13) of a cooling medium with a extinguishing effect is closed by a second terminal (12), wherein the receiver (1) comprises a pairing button for pairing the wireless communication (9) with the transmitter (7), an internal or external power supply, at least one LED for setting the pairing with the transmitter (7), at least one LED for monitoring an error of the transmitter (7) arranged in the protected area (6), and further comprises RF receiving components for communication via WIFI or Bluetooth or LAN or other possible transmission networks.

2. The system according to claim 1, wherein the carrier (13) of the cooling medium with extinguishing effect is a low pressure device with a pressure up to 1 MP and is made of polymeric materials.

3. The system of claim 1, wherein the communication control unit (15) includes a temperature or smoke sensor or a light spectrum sensor, an RF transmitter for wireless communication (9) between the transmitter (7) and the receiver (1) via a WIFI or Bluetooth or LAN or other possible transmission networks, a pairing button for pairing the wireless communication (9) with the receiver (1), and further the communication control unit (15) includes the control LED for setting and pairing with the receiver (1).

4. The system according to claim 1, wherein the receiver (1) is DIN rail compatible.

5. The system according to claim 1, wherein the transmitter (7) is externally powered.

6. The system according to claim 1, wherein the transmitter (7) further comprises a passive cooling or extinguishing function.

7. The system according to claim 1, wherein activation of the system is from 30° C. in the protected area.

8. The system according to claim 1, wherein an electrical circuit in which a protected area is arranged is disconnected, and in which rising temperature or smoke or light spectrum is detected by a sensor, based on a signal of a respective transmitter (7) arranged in the subject protected area (6) sent via a receiver to a disconnector (3).

9. The system according to claim 1, wherein the receiver (1) comprises a digital or analogue signaling/system initiation indication, i.e. a release of a cooling medium with extinguishing effects from a carrier (13) arranged in a transmitter (7), said transmitter (7) being arranged in the at least one protected area (6), wherein due to increasing temperature, this the carrier (13) is damaged, the cooling medium with extinguishing effects is released into the protected area (6), and this signal is sent by the transmitter (7) to the receiver (1).

10. The system according to claim 1, wherein dimensions of the transmitter (7) are adapted to a size of the at least one protected areas (6) in which the transmitter (7) is arranged.
